(19) United States
(12) Patent Application Publication
(10) Pub. No.: US 2016/0165798 A1
(43) Pub. Date: Jun. 16, 2016

(54) SPROCKET ASSEMBLY

(71) Applicant: LAVERDA SPA, Hesston, KS (US)

(72) Inventor: Davide DE BACCO, Breganze (IT)

(21) Appl. No.: 14/902,745

(22) PCT Filed: Jul. 2, 2014
(86) PCT No.: PCT/EP2014/001806

§ 371 Date: Jan. 4, 2016

(30) Foreign Application Priority Data
Jul. 4, 2013 (IT) MI2013A001128

(51) Int. Cl. A01D 69/00; A01D 34/83; F16H 55/30

(52) U.S. Cl. CPC A01D 69/00; F16H 55/30; A01D 34/833; A01D 34/831; A01D 2101/00

(57) ABSTRACT

A sprocket assembly comprises a first sprocket (54) which serves as a hub for a larger second sprocket. An annular extension member (70) is secured to the outer periphery of first sprocket (54) to prevent relative axial movement. The annular extension (70) comprises teeth (77,81) on both an inner edge (76) and an outer edge (80). The inner set of teeth (77) may be rounded so as to mate and lock with the profile of teeth of the first sprocket (54). The outer set of teeth (81) provide the larger second sprocket and engage with a chain (56).

The invention relates to sprockets and sprocket/chain drive systems.

Sprockets are commonly employed in chain-drive systems in a host of different applications from bicycles to machinery. One example application is combine harvesters which include several chain-drive and belt-pulley systems to convey torque from one shaft to another.

The header, for example, commonly includes a cross-auger for gathering crop material (cut by a cutterbar) inwardly from the outer reaches of the header's width toward a centrally-disposed outlet from where the crop material is fed into an elevator for conveyance to the threshing gear. Other moving parts on the header include the reel, the cutterbar and sometimes draper belts, each of which are driven by a belt-pulley drive or a chain-sprocket drive.

The cross-auger is usually driven by a chain-sprocket drive in which a sprocket is keyed onto one end of a drive shaft supporting the auger, the sprocket being mounted on an outside of a header sidewall along with the other drives.

To cater for different crops and harvesting conditions it is desirable to drive the auger at a different speeds with respect to the other moving header parts. Today, equipment manufacturers supply combine harvesters with replacement sprockets of different sizes to enable the operator to change the sprockets as required. However, the process of changing the sprockets is cumbersome and time-consuming. For example, some known auger drives are provided with slip clutches on the outside of the driven sprocket which must be removed when the sprockets are changed.

It is an object of the invention to provide an improved sprocket assembly which reduces the hassle in changing sprockets of different sizes.

According to the invention there is provided a sprocket assembly comprising a first sprocket and an annular extension member secured to the first sprocket to prevent relative axial movement, and comprising teeth on both an inner edge which mesh with teeth on an outer edge of the first sprocket, and on an outer edge, wherein the teeth on the outer edge of the first sprocket and the teeth on the outer edge of the extension member have matching profiles. Therefore, the annular extension member, when attached to the first sprocket, provides a second sprocket having a larger diameter than the first sprocket.

The provision of the annular extension member facilitates simple alteration of the effective diameter of the sprocket without removal of a central hub and any associated clutch devices. To decrease the number of teeth (and thus the sprocket diameter) the annular extension is simply detached from the first (or inner) sprocket. To increase the number of teeth the annular extension is attached to the first sprocket.

In one configuration the extension member is secured to the first sprocket to prevent relative axial movement. A plurality of discontinuities (that is absent teeth) are preferably provided between pairs of teeth on the inner edge to receive suitable securing means such as bolts. Washers and nuts (fitted to the bolts) engage the respective surfaces of the sprocket and extension member to hold them together. Alternative means to secure the extension member in place are envisaged, for example an R-clip.

A second annular extension member having a greater diameter than the first extension member may be provided, the second extension member comprising teeth on both an inner edge which mesh with teeth on an outer edge of the first extension member, and on an outer edge for providing a third sprocket having a larger diameter than the second sprocket. Advantageously, a three-speed chain-sprocket system having three optional sprocket diameters may be provided with an inner sprocket permanently keyed to a shaft and two outer extension members.

Further advantages of the invention will become apparent from reading the following description of a specific embodiment with reference to the appended drawings in which:

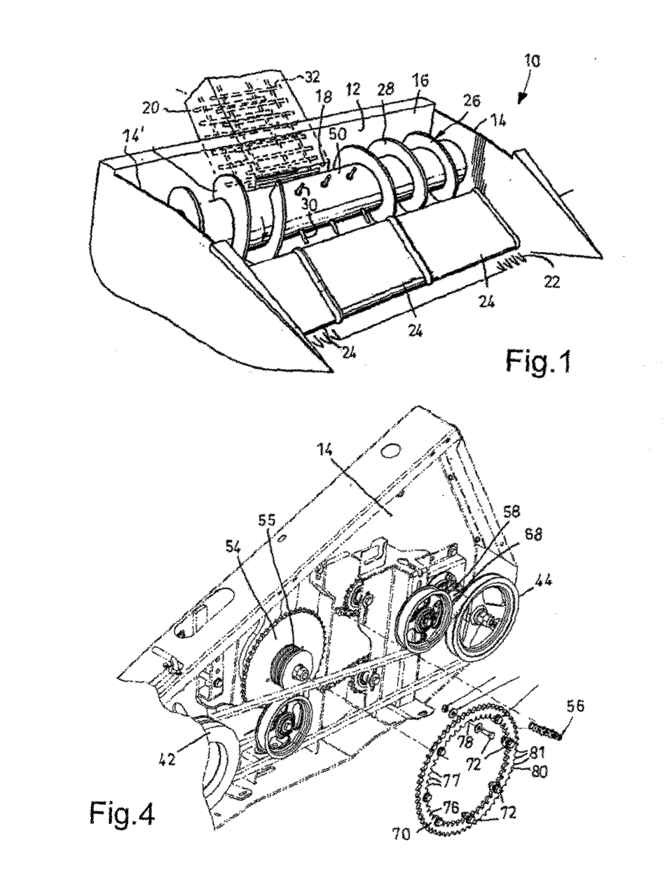

FIG. 1 is a right-hand perspective view of a combine header;

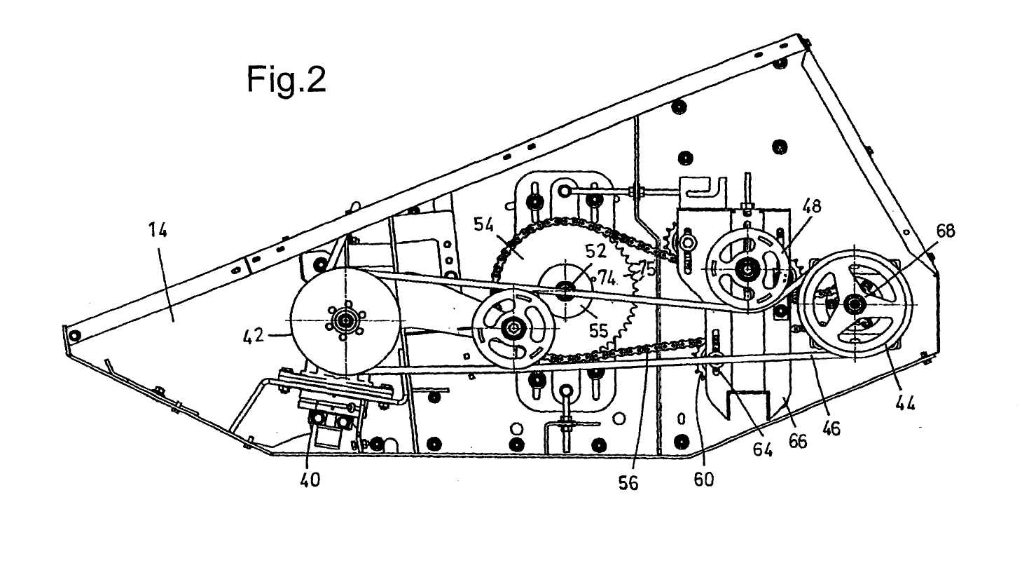

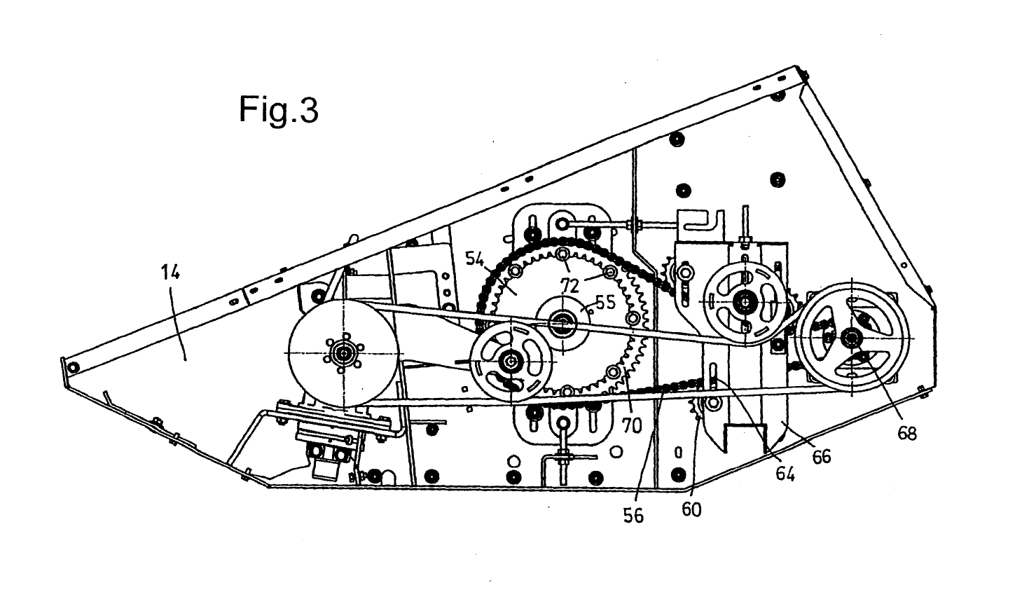

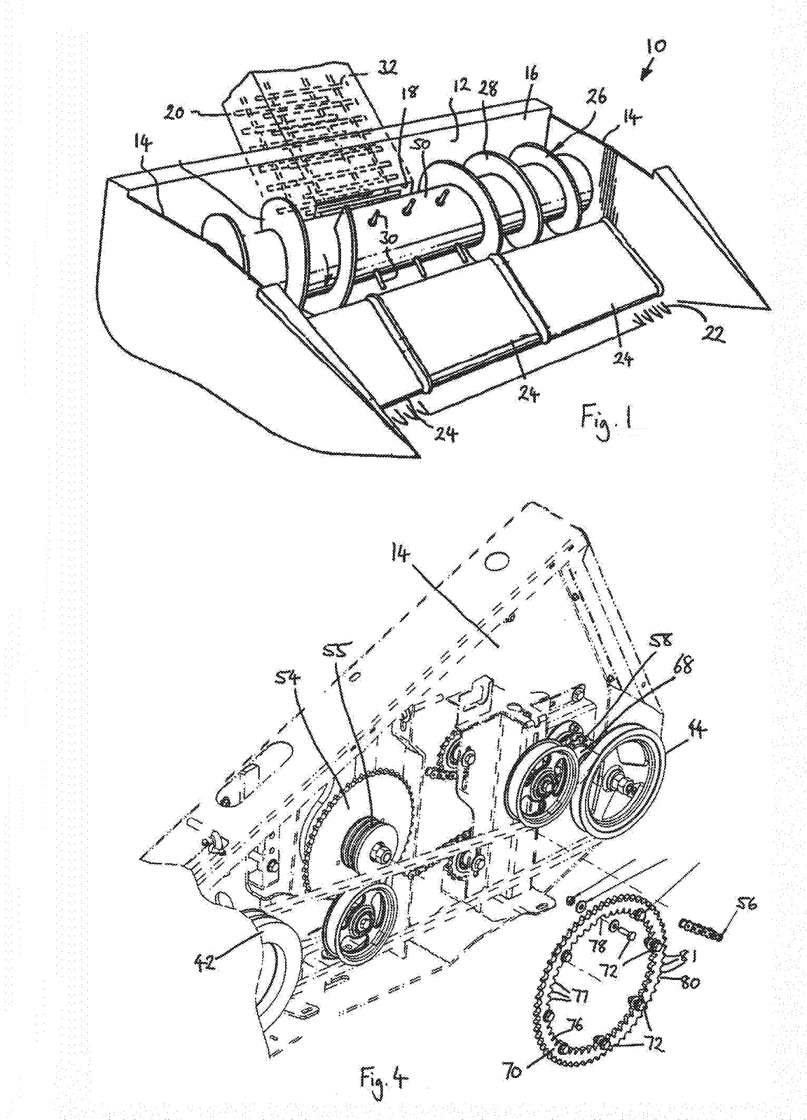

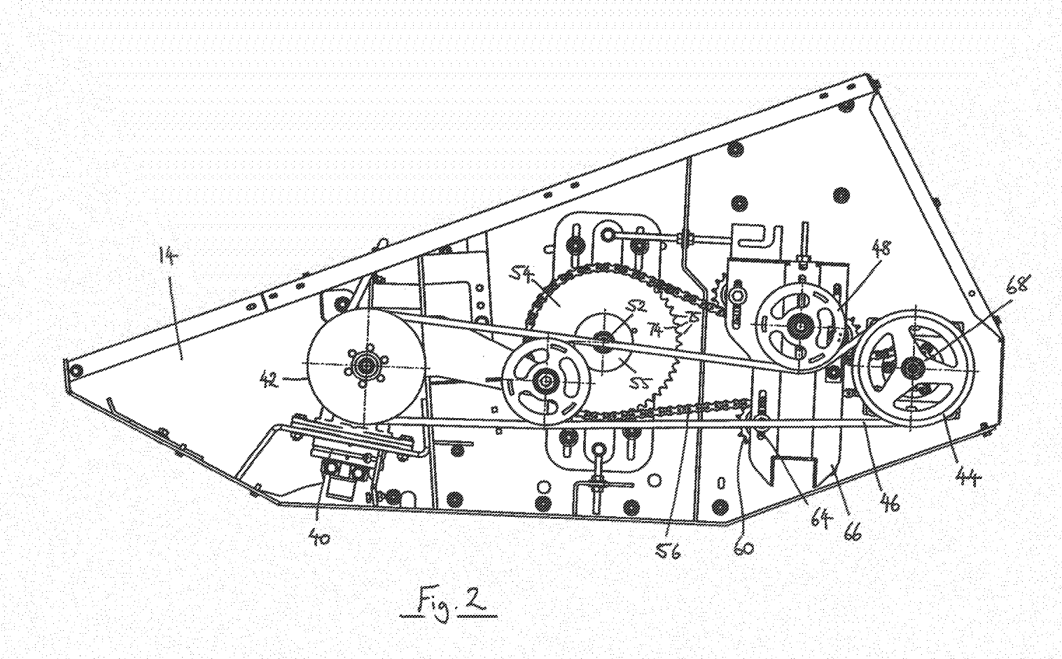

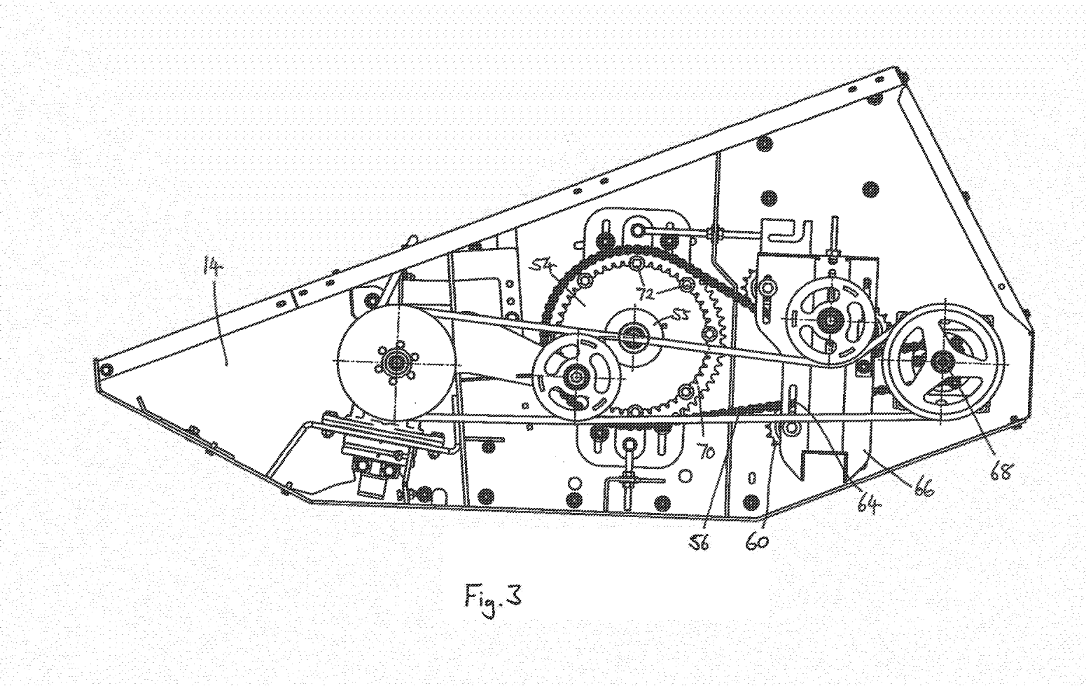

FIGS. 2 and 3 are left-hand elevation cutaway views of a combine header embodying a sprocket assembly in accordance with the invention shown in two different configurations;

FIG. 3 is a left-front isometric view of the header shown in FIG. 2 with the sprocket assembly shown in exploded form.

With reference to FIG. 1 a header 10 for a combine harvester (not shown) includes a frame 12 having two side walls 14, 14′ and a rear wall 16 which includes a centrally-disposed opening 18 in communication with an elevator housing 20. As the header 10 progresses across a crop field a cutterbar 22 severs the standing crop which is then conveyed rearwardly by draper belts 24 before engaging a cross auger 26. Flighting 28 provided on the cross auger 26 gathers the crop inwardly toward the central opening 18 before retractable fingers 30 propel the crop through the opening 18 into the elevator housing 20. A chain and slat elevator 32 conveys the crop stream toward the threshing apparatus (not shown).

The header 10 typically also comprises a reel which guides the crop towards the header 10 as it advances across the field. It should be understood that the reel is not shown in FIG. 1 for clarity purposes.

The cutterbar 22, draper belts 24 and cross auger 26 are driven by various drive lines mounted on the outside of left-hand side wall 14 as shown in FIGS. 2, 3 and 4. Cutterbar 22 has associated therewith a cutterbar gearbox 40 which is driven by a first pulley 42 which itself is driven by a second pulley 44 via a belt 46 in a known manner. Second pulley 44 is keyed onto, and derives from, a driveshaft 68. A vertically adjustable tensioning pulley 48 is also provided to adjust the tension on belt 46.

Cross auger 26 includes a core tube 50 which is mounted to a driveshaft which rotates on an axis represented at 52 (FIG. 2). In a known manner a first sprocket 54 is keyed onto the driveshaft 52 for rotation therewith. First sprocket 54 is driven via a chain 56 by a drive sprocket 58 keyed on to the same driveshaft 68 as pulley 44. A tensioning sprocket 60 is mounted for rotation on a pin 62 having a vertical position which can be adjusted within a slot 64 provided in a support plate 66 secured to the header side wall 14.

A slip clutch 55 is located on the driveshaft 52 outside of the first sprocket 54 in a known manner. The slip clutch 55 includes a coil spring retained by a washer and permits the first sprocket 54 to disengage from the driveshaft 52 in an overload condition.

Torque generated by the harvester engine is conveyed from driveshaft 68 to the cross auger 26 via sprockets 58,54 and chain 56. As will be appreciated, the ratio of sizes between drive sprocket 58 and first sprocket 54 affects the rotation speed of the cross auger 26 with respect to the other moving header parts.

In accordance with the invention an annular sprocket extension 70 is provided to enable an operator to simply change the relative drive speed of the cross auger 26 without removal of the clutch 55. In a second configuration shown in FIG. 3 the sprocket extension 70 is secured to the circumference of first sprocket 54 and secured against relative axial movement by eight bolts 72.

In more detail and with reference to FIGS. 2 and 4, first sprocket 54 has an outer edge 74 which defines a set of teeth 75 for engagement with chain 56. Annular extension 70 has an inner edge 76 which defines a set of rounded teeth 77 which have a profile designed to mesh with teeth 75 on first sprocket 54.

Inner edge 76 of extension 70 includes eight discontinuities 78 effectively formed by the omission of a respective inner tooth 77 at spaced intervals around the circumference of the annulus.

Extension 70 further includes an outer edge 80 which defines a second set of teeth 81 designed to mesh with chain 56 in the second configuration. The teeth of the outer sets 75, 81 have like profiles so as to engage with chain 56 in the respective configurations. In other words, the upstanding profile of the teeth provided on the outer edge 74 of first sprocket 54 is the same as the upstanding profile of the teeth provided on the outer edge 80 of annular extension 70.

### Operation

In the event of an operator wishing to reduce the relative rotation speed of auger 26, the effective size of first sprocket 54 is increased by the attachment of extension 70. To execute this process the operator firstly breaks the chain 56 by simple operation of a dedicated detachment clip (not shown) which facilitates easy braking.

Secondly, extension 70 is mounted upon first sprocket 54 wherein the inner teeth 77 mesh with a first set of outer teeth 75. Eight bolts 72 are inserted through the gaps provided by discontinuity 78. Washers 82 are included on the bolts 72 to grip the sides of first sprocket 54 and extension 70 whilst a nut 83 is tightened to keep the bolts 72 and washers 82 in place. The addition of extension 70 effectively provides a second sprocket having a greater diameter (and a greater number of teeth) than first sprocket 54. In other words, the first sprocket 54 serves as a supporting hub for the larger second sprocket shown in position in FIG. 3.

Thirdly, tensioning sprocket 60 is adjusted to effectively lengthen chain 56 before the loose ends are reconnected by the operator. Depending on the geometry of the sprockets and chain path, it may be necessary to add additional links into the chain 56.

It should be understood that to increase the relative speed of auger 26 the above described process is executed in reverse so as to remove the extension 70 thus changing from the configuration shown in FIG. 3 to that shown in FIG. 2.

Although described in relation to a harvester header, the application of a sprocket assembly with the provision of an annular extension is envisaged for application in host of different chain and sprocket drive systems.

In summary a sprocket assembly comprises a first sprocket which serves as a hub for a larger second sprocket. An annular extension member is secured to the outer periphery of first sprocket to prevent relative axial movement. The annular extension comprises teeth on both an inner edge and an outer edge. The inner set of teeth may be rounded so as to mate and lock with the profile of teeth of the first sprocket. The outer set of teeth provide the larger second sprocket and engage with a chain.

### Alternative Embodiment

In an embodiment not illustrated, a second annular extension member is provided having a greater diameter than the first extension member. The second extension member comprises teeth on both the inner ant outer edges. Rounded teeth on the inner edge mesh with teeth on the outer edge of the first extension member. Teeth on the outer edge of the second extension member provide those of a third sprocket having a larger diameter than the second sprocket.

1. A sprocket assembly comprising:
a first sprocket; and,
an annular extension member secured to the first sprocket to prevent relative axial movement;
wherein the annular extension member comprises teeth on both an inner edge and on an outer edge;
wherein the teeth on the inner edge of the annular extension member mesh with teeth on an outer edge of the first sprocket; and,
wherein the teeth on the outer edge of the first sprocket and the teeth on the outer edge of the extension member have matching profiles.

2. The sprocket assembly according to claim 1, wherein the inner edge comprises discontinuities between pairs of teeth for receiving a bolt which secures the extension member to the first sprocket.

3. The sprocket assembly according to claim 1, further comprising a second annular extension member having a greater diameter than the first extension member, the second extension member comprising teeth on both an inner edge which mesh with teeth on an outer edge of the first extension member, and on an outer edge for providing a third sprocket having a larger diameter than the second sprocket.

4. A harvester header for a self-propelled harvester comprising a transverse auger configured to gather crop material inwardly towards a centrally-disposed outlet, the auger being driven by a chain and sprocket system which includes a sprocket assembly comprising:
a first sprocket; and,
an annular extension member secured to the first sprocket to prevent relative axial movement;
wherein the annular extension member comprises teeth on both an inner edge and on an outer edge:
wherein the teeth on the inner edge of the annular extension member mesh with teeth on an outer edge of the first sprocket; and,
wherein the teeth on the outer edge of the first sprocket and the teeth on the outer edge of the extension member have matching profiles.
